(19) United States
(12) Patent Application Publication
(10) Pub. No.: US 2026/0243433 A1
(43) Pub. Date: Aug. 20, 2026

(54) FIRE PIT WITH DETACHABLE HOUSING

(71) Applicant: MONUMENT GRILL LLC, Lewes, DE (US)

(72) Inventors: Huanyun Mao, CIXI (CN); Xianghua Liu, CIXI (CN); Junye Mi, CIXI (CN); Xuefei Mao, CIXI (CN)

(21) Appl. No.: 19/643,740

(22) Filed: Apr. 9, 2026

(30) Foreign Application Priority Data
Mar. 2, 2026 (CN) 202620249610.3

(51) Int. Cl. F24B 3/00

(52) U.S. Cl. CPC F24B 3/00

(57) ABSTRACT

A fire pit with a detachable housing includes: a housing; a liner disposed within the housing; and a grate disposed at a bottom of the liner. The housing includes a plurality of splicing plates. The plurality of splicing plates are annularly surrounding an outer position away from an outer wall of the liner so that a clearance space exists between an inner surface of each splicing plate and the outer wall of the liner, and side portions of every two adjacent splicing plates are latched with each other.

### TECHNICAL FIELD

The present invention relates to the technical field of fire pits, and particularly to a fire pit with a detachable housing.

### BACKGROUND

A fire pit is one of the commonly used appliances for scenarios such as outdoor heating, courtyard leisure, and outdoor gathering. The core function of the fire pit is accommodating combustible materials such as charcoal and firewood through the liner, and realizing purposes such as heating and item heating by using heat generated by combustion. As an important component of the fire pit, a housing is mainly used for protecting the liner and isolating high temperatures to prevent scalding accidents for users, while having dual functions of aesthetic decoration and liner fixation. A grate is disposed at a bottom of the liner and is a core component for supporting combustible materials and assisting ventilation. A recess formed by a downward recess in a middle part of the grate can effectively prevent combustible materials from scattering, ensuring safety during use of the fire pit.

For a fire pit with a detachable housing, core design requirements include convenience of disassembly, robustness of assembly, rationality of heat dissipation, safety of use, and adaptability to outdoor scenarios. It is required to reduce volume through disassembly to facilitate transportation and storage, ensure stability of the overall structure after the housing is assembled, and realize high-efficiency heat dissipation through a reasonable structural design to avoid safety hazards caused by excessive surface temperature of the housing. However, conventional fire pits with a detachable housing have significant defects in structural design of the housing, making it difficult to balance the above core requirements. Specific problems are as follows:

First, conventional fire pit housings mostly adopt an integrated fixed structure and cannot be disassembled, resulting in occupying a large space during transportation, being difficult to place flexibly during storage, and having poor adaptability to scenarios. Some detachable housings adopt a simple assembly structure, and no reliable latching mechanism is provided between splicing plates. Connection is realized only through bolt fastening or simple overlapping. A disassembly process needs using specialized tools, and an operation process is cumbersome. Moreover, after repeated disassembly, loosening phenomena are prone to occur at assembly, affecting stability of the overall structure of the fire pit.

Second, conventional fire pit housings are mostly arranged closely against the outer wall of the liner, and no reasonable clearance space is reserved. High temperatures generated by combustion in the liner are directly conducted to the surface of the housing, leading to a sharp increase in temperature of the housing and easily causing accidental scalding of users. Meanwhile, a design without clearance space leads to heat being unable to be effectively dissipated. Long-term accumulation of high temperatures not only accelerates aging and deformation of housing materials, but also may ignite surrounding flammable items. The design is particularly unsuitable for scenarios with a high density of personnel activities, and safety risks are prominent.

Third, between splicing plates of conventional detachable housings, either no specialized latching structure is provided, or a latching mechanism design is unreasonable, resulting in side portions of adjacent plates fitting too tightly or too loosely, and a stable connection structure cannot be formed. During outdoor use, under the action of external forces such as wind and collision, splicing plates are prone to loosening, displacement, or even falling off, which not only affects stability of the overall structure of the fire pit, but also may lead to displacement of the liner and scattering of combustible materials, thereby causing safety accidents.

Fourth, conventional assembly-type housing plates have a single design form, resulting in a stiff overall shape and insufficient aesthetics after assembly, making it difficult to meet decoration needs of scenarios such as courtyard and outdoor leisure. Meanwhile, some assembly structures sacrifice convenience of disassembly for the sake of robustness of connection, and some other structures lead to a loose overall structure for the sake of improving convenience of disassembly, failing to balance practicality and aesthetics. Its market competitiveness needs to be improved.

### SUMMARY

In order to achieve the above objectives, the present invention adopts the following technical solutions: A fire pit with a detachable housing includes:

a housing;

a liner disposed within the housing; and

a grate disposed at a bottom of the liner;

wherein the housing includes a plurality of splicing plates, the plurality of splicing plates are annularly surrounding an outer position away from an outer wall of the liner so that a clearance space exists between an inner surface of each splicing plate and the outer wall of the liner, and side portions of every two adjacent splicing plates are latched with each other.

Further, a middle part of the grate is recessed downward to form a recess for accommodating combustible materials; and an included angle exists between inner surfaces of every two adjacent splicing plates, and the included angle is an obtuse angle.

Further, a first connecting portion and a second connecting portion are respectively formed on opposite side portions of each splicing plate, and when two adjacent splicing plates are connected, the first connecting portion is latched onto the second connecting portion to form a connection.

Further, the first connecting portion includes a latching groove, the second connecting portion includes a latching portion matching the latching groove, a latching protrusion and a latching hole are respectively formed on the latching groove and the latching portion, and the latching portion is latched within the latching groove so that the latching protrusion is latched in the latching hole.

Further, the first connecting portion further includes a first connecting plate, a first latching plate, and a second latching plate, the first connecting plate is formed on one side portion of the splicing plate, the first latching plate is connected to the first connecting plate, the second latching plate is connected to the first latching plate, the first latching plate is located between the first connecting plate and the second latching plate to form the latching groove, and the latching hole is formed on the first latching plate, the second latching plate, or a connection between the first latching plate and the second latching plate.

Further, the second connecting portion further includes a second connecting plate, the second connecting plate is formed on the other side portion of the splicing plate, the latching portion is a third latching plate connected to the second connecting plate, the third latching plate is arranged extending toward the first connecting portion, and the latching protrusion is arranged on the third latching plate.

Further, a first through hole is provided on the third latching plate, a second through hole is provided on the first latching plate, and when the first connecting portion is latched onto the second connecting portion, the first through hole and the second through hole are aligned with each other.

Further, the first connecting portion and the second connecting portion on each splicing plate are both arranged in a tilted manner, and the first connecting portion and the second connecting portion have the same tilt direction.

Further, the splicing plate includes a first connecting surface and a second connecting surface, the first connecting surface and the second connecting surface are arranged adjacent to each other, and a plane in which the first connecting surface is located and a plane in which the second connecting surface is located intersect to form a specified angle to form a flow-guiding surface for guiding airflow on an inner wall of the housing, wherein the specified angle is an obtuse angle.

Further, the first connecting surface and the second connecting surface are both triangular structures, and the triangular structure of the first connecting surface and the triangular structure of the second connecting surface are inverted relative to each other.

The beneficial effects of the present invention lie in:

The housing is assembled by using a plurality of splicing plates, and side portions of adjacent splicing plates are latched with each other, which replaces conventional integrated fixed structures or simple assembly structures. Assembly and disassembly operations can be completed without using specialized tools, and an operation process is simple and efficient. Meanwhile, after disassembly, splicing plates can be separated and stored, which greatly reduces an overall volume, reduces a space occupancy rate during transportation, facilitates flexible storage, effectively solves problems of inconvenient transportation, difficult storage, and poor adaptability to scenarios of conventional fire pits, and improves portability and scenario adaptability of the product.

A plurality of splicing plates are annularly surrounding an outer position away from the outer wall of the liner, so that a clearance space is formed between the inner surface of the splicing plate and the outer wall of the liner. The structural design completely solves the defect that conventional housings are closely attached to the liner and heat cannot be effectively dissipated. High temperatures generated by combustion in the liner can form air convection through the clearance space, realizing high-efficiency heat dissipation, avoiding high temperatures from being directly conducted to the surface of the housing to cause a sharp increase in temperature, and effectively preventing accidental scalding of users. Meanwhile, aging and deformation effects on housing materials caused by accumulation of high temperatures are reduced, a risk of igniting surrounding flammable items is reduced, and safety during use of the fire pit is significantly improved, making it suitable for scenarios with a high density of personnel activities.

Side portions of every two adjacent splicing plates are latched with each other to form a reliable connection structure, which replaces defects such as no specialized latching mechanism or unreasonable latching design in the prior art, and effectively avoids a problem that adjacent plates fit too tightly or too loosely. During outdoor use, external forces such as wind and collision can be effectively resisted, and splicing plates are prevented from loosening, displacement, or falling off, ensuring stability of the overall structure of the housing. Meanwhile, safety hazards such as displacement of the liner and scattering of combustible materials caused by falling off of plates are avoided, and safety and reliability of use of the fire pit are further improved.

For the assembly structure of a plurality of splicing plates, a number of splicing plates can be flexibly adjusted according to a size of the liner to adapt to installation needs of liners of different specifications, solving a defect of poor adaptability of conventional housing structures. Meanwhile, an overall shape formed by the splicing plates surrounding annularly is regular and beautiful. Compared with the problem of stiff shapes of conventional assembly structures, decoration needs of scenarios such as courtyard and outdoor leisure can be better met, balance between practicality and aesthetics is realized, and market competitiveness of the product is effectively improved.

### BRIEF DESCRIPTION OF THE DRAWINGS

FIG. 1 is a schematic structural view of a fire pit in an embodiment of the present invention.

FIG. 2 is a sectional view of the fire pit shown in FIG. 1.

FIG. 3 is a schematic view of a splicing plate in an embodiment of the present invention.

FIG. 4 is a schematic connection view of the splicing plate in the embodiment shown in FIG. 3.

FIG. 5 is an enlarged view of part A in FIG. 4.

FIG. 6 is a sectional bottom view of the fire pit shown in FIG. 1.

FIG. 7 is an enlarged view of part B in FIG. 6.

Reference numerals are as follows: 100, housing; 101, first connecting surface; 102, second connecting surface; 103, first connecting plate; 104, first latching plate; 105, second latching plate; 106, second through hole; 107, latching hole; 108, second connecting plate; 109, third latching plate; 110, latching protrusion; 111, first through hole; 112, first retaining plate; 113, second retaining plate; 114, third through hole; 115, splicing plate; 116, included angle; 117, first connecting portion; 118, second connecting portion; 119, latching groove; 120, latching portion; 200, top cover; 300, liner; 400, grate; 401, recess; 500, ash tray; 600, bottom wall; 601, air inlet slot.

### DETAILED DESCRIPTION OF THE DISCLOSURE

The present disclosure will be described in detail below with reference to the drawings and in combination with the embodiments.

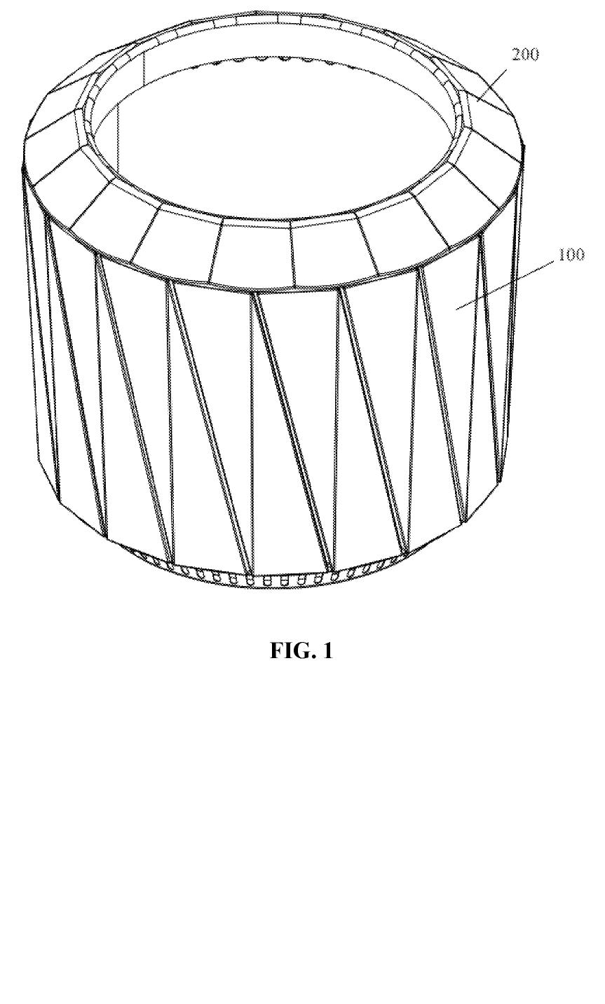

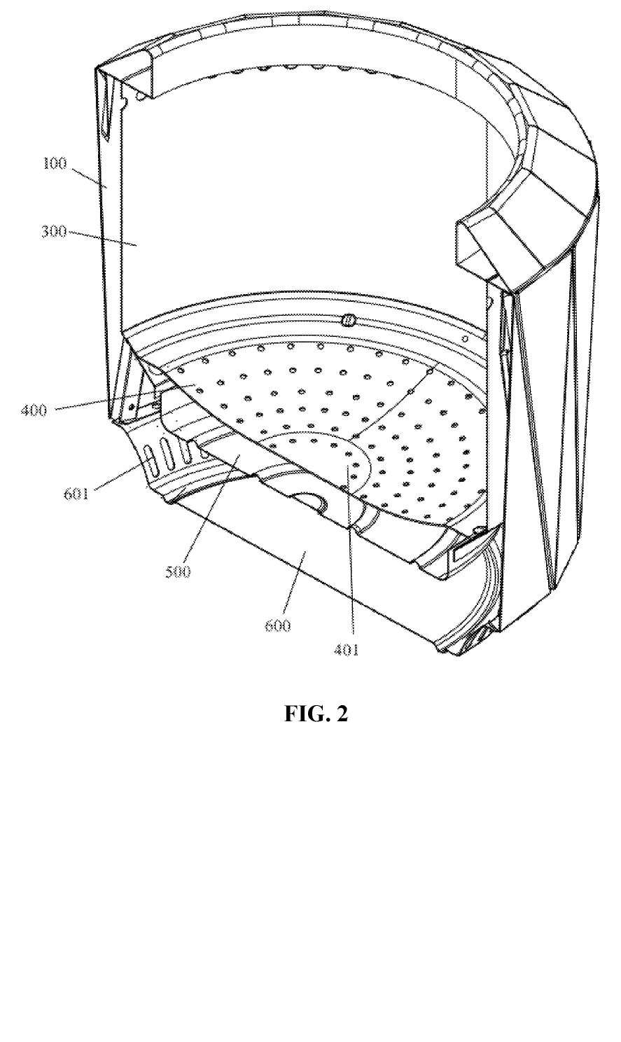

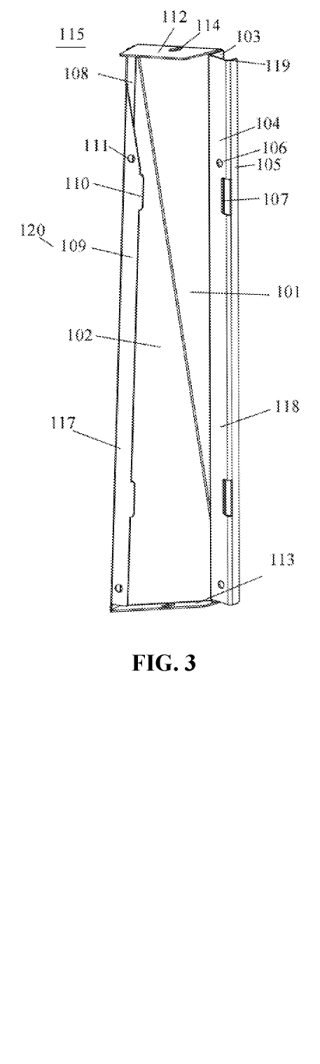

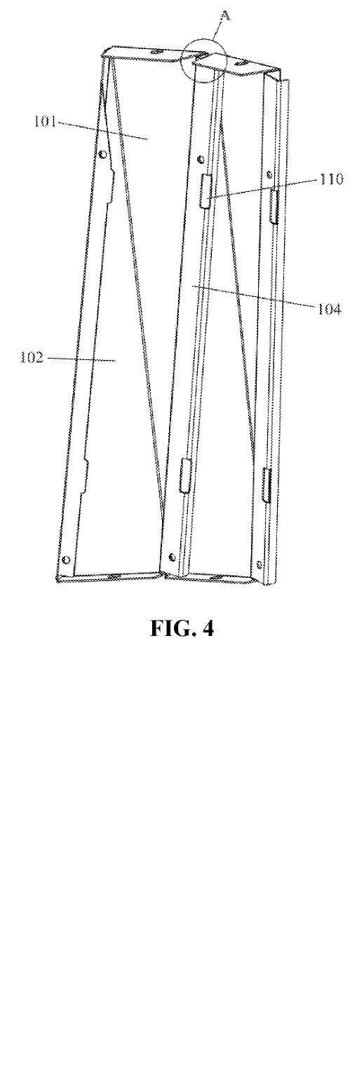

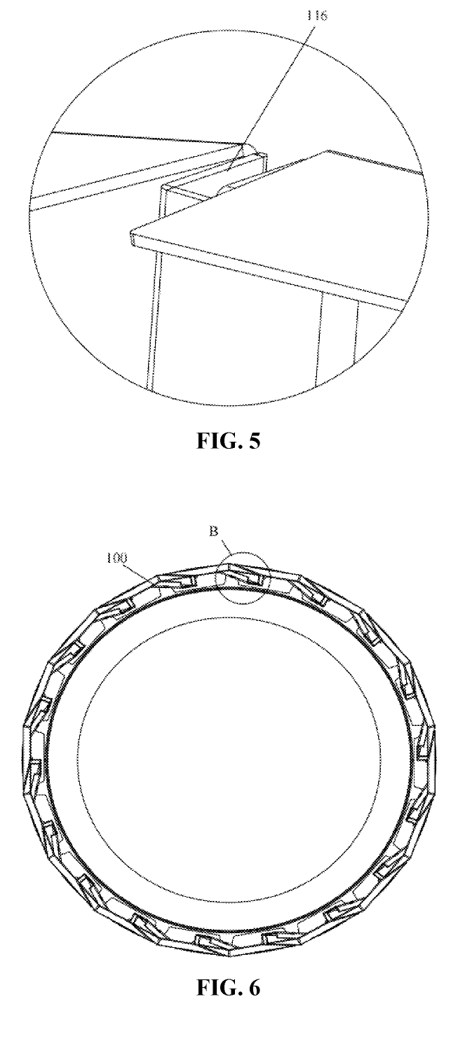

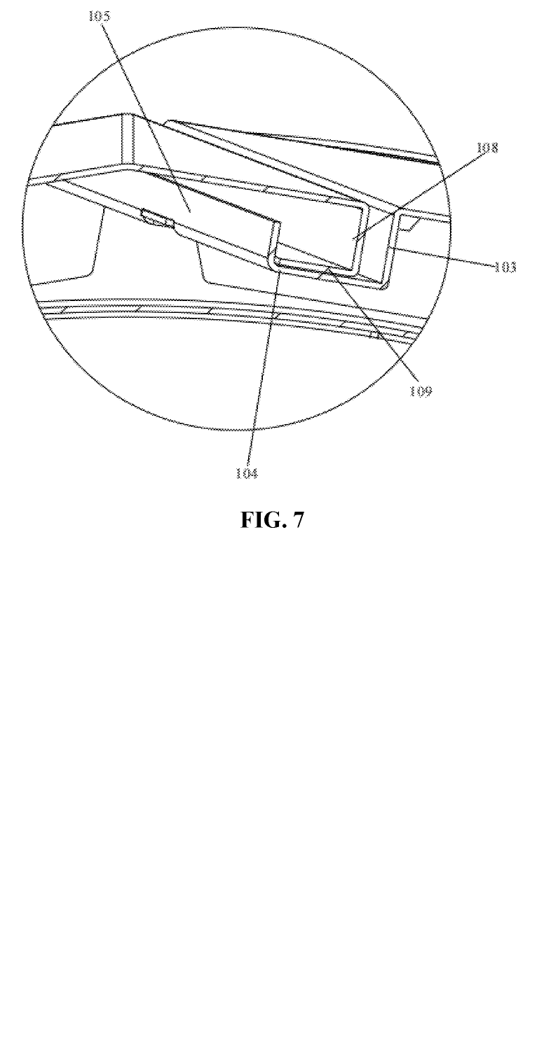

As shown in FIGS. 1 to 6, a fire pit with a detachable housing includes a housing 100, a liner 300, a grate 400, an ash tray 500, a bottom wall 600, and a top cover 200.

The liner 300 is disposed within the housing 100 for blocking flames from escaping. The grate 400 is disposed at a bottom of the liner 300, and a middle part of the grate 400 is recessed downward to form a recess 401 for accommodating combustible materials. The ash tray 500 is disposed below the grate 400 for receiving ash generated on the grate 400. The bottom wall 600 is connected to a bottom of the housing 100, and a plurality of air inlet slots 601 are provided on the bottom wall 600. The top cover 200 is covered on a top of the splicing-type housing 100 and fixes the housing 100 together with the bottom wall 600. The bottom wall 600 and the top cover 200 respectively limit and fix a bottom and a top of the housing 100, and act together with latching-type connecting portions to further ensure overall stability of the structure of the housing 100. The liner 300 is made of high-temperature resistant material, which is capable of effectively blocking flames from directly contacting the housing 100, avoiding damage to the housing 100 due to high temperatures, and preventing fire leakage from causing safety accidents. The design where the middle part of the grate 400 is recessed downward to form the recess 401 can centrally accommodate combustible materials such as charcoal and firewood, making combustion more sufficient and heat release more concentrated, thereby improving heating and grilling effects. The arrangement of the ash tray 500 is convenient for collecting ash generated after combustion, preventing the ash from scattering to a bottom of the fire pit and being difficult to clean, and keeping the interior of the fire pit tidy. The air inlet slots 601 on the bottom wall 600 can provide sufficient oxygen for combustion and promote combustion efficiency. The top cover 200 can not only fix the housing 100 but also prevent sparks from splashing to a certain extent, and the top cover 200 can be disassembled as needed, which is convenient for adding combustible materials or performing grilling operations.

The housing 100 includes a plurality of splicing plates 115. The plurality of splicing plates 115 are annularly surrounding an outer position away from an outer wall of the liner 300 so that a clearance space exists between an inner surface of each splicing plate 115 and the outer wall of the liner 300. Side portions of every two adjacent splicing plates 115 are latched with each other so that an included angle 116 exists between inner surfaces of every two adjacent splicing plates 115, and the included angle 116 is an obtuse angle, so that the splicing plates 115 form a cylindrical housing structure after assembly.

Further, a first connecting portion 117 and a second connecting portion 118 are respectively formed on opposite side portions of each splicing plate 115. When two adjacent splicing plates 115 are connected, the first connecting portion 117 is latched onto the second connecting portion 118 to form a connection. The latching design of the first connecting portion 117 and the second connecting portion 118 realizes tool-free rapid assembly. A user only needs to align the first connecting portion 117 of an adjacent splicing plate 115 with the second connecting portion 118 and apply appropriate pressure to complete latching, and disassembly can be performed by applying force in a reverse direction, which is convenient and efficient.

The first connecting portion 117 includes a latching groove 119, and the second connecting portion 118 comprises a latching portion 120 matching the latching groove 119. A latching protrusion 110 and a latching hole 107 are respectively formed on the latching groove 119 and the latching portion 120. The latching portion 120 is latched within the latching groove 119 so that the latching protrusion 110 is latched in the latching hole 107. When the latching portion 120 is inserted into the latching groove 119, the latching protrusion 110 can be precisely embedded in the latching hole 107 to form longitudinal positioning, further limiting relative displacement between adjacent splicing plates 115 in a vertical direction. Cooperating with lateral positioning, multi-dimensional fixing of the connecting portion is realized, significantly improving the vibration resistance of the assembly structure. The tight matching between the latching protrusion 110 and the latching hole 107 can also effectively prevent the connecting portion from loosening during use, ensuring structural stability of the housing 100 of the fire pit under complex working conditions such as high-temperature roasting and outdoor use.

Still further, the first connecting portion 117 further includes a first connecting plate 103, a first latching plate 104, and a second latching plate 105. The first connecting plate 103 is formed on one side portion of the splicing plate 115. The first latching plate 104 is connected to the first connecting plate 103, and the second latching plate 105 is connected to the first latching plate 104. The first latching plate 104 is located between the first connecting plate 103 and the second latching plate 105 to form the latching groove 119. The latching hole 107 is formed on the first latching plate 104, the second latching plate 105, or a connection between the first latching plate 104 and the second latching plate 105. The second connecting portion 118 further includes a second connecting plate 108. The second connecting plate 108 is formed on the other side portion of the splicing plate 115. The latching portion 120 is a third latching plate 109 connected to the second connecting plate 108. The third latching plate 109 is arranged extending toward the first connecting portion 117, and the latching protrusion 110 is arranged on the third latching plate 109.

The first latching plate 104 is perpendicularly connected to an inner edge of the first connecting plate 103, and the second latching plate 105 is parallel to the first connecting plate 103 and extends from a free end of the first latching plate 104 in a direction away from the first connecting plate 103. Accordingly, the first connecting plate 103, the first latching plate 104, and the second latching plate 105 together enclose to form a latching groove 119 with a "匚"-shaped cross-section. The latching hole 107 can be provided at a middle position of the first latching plate 104, and a shape of the latching hole 107 matches the latching protrusion 110. For example, the latching hole 107 can be a circular or square through hole. The second connecting plate 108 is formed on the other side portion of the splicing plate 115 and matches a thickness and a height of the first connecting plate 103. The third latching plate 109 is perpendicularly connected to an inner edge of the second connecting plate 108, and a length of the third latching plate 109 is slightly smaller than a depth of the latching groove 119 so as to be smoothly inserted into the latching groove 119. The latching protrusion 110 is integrally formed on an outer surface of the third latching plate 109 and is arranged corresponding to the position of the latching hole 107. A height of the latching protrusion 110 is slightly smaller than a depth of the latching hole 107 to ensure that stable snap-fitting can be formed after latching. When two adjacent splicing plates 115 are connected, the third latching plate 109 of one splicing plate 115 is aligned with an opening of the latching groove 119 of another splicing plate 115 and pushed in along a horizontal direction. At this time, the latching protrusion 110 on the third latching plate 109 contacts the first latching plate 104 or the second latching plate 105 in the latching groove 119 and generates slight elastic deformation. When the latching protrusion 110 reaches the position of the latching hole 107, the latching protrusion 110 is embedded into the latching hole 107 under action of the elastic recovery force of the material itself, realizing reliable latching of adjacent splicing plates 115.

Further, a first through hole 111 is provided on the third latching plate 109, and a second through hole 106 is provided on the first latching plate 104. When the first connecting portion 117 is latched onto the second connecting portion 118, the first through hole 111 and the second through hole 106 are aligned with each other. Through the arrangement of the first through hole 111 and the second through hole 106, an auxiliary connecting member such as a pin or a snap can be inserted to further enhance the pull-out resistance of the connecting portion, meeting needs for structural reliability in special scenarios.

It should be noted that the first connecting portion 117 and the second connecting portion 118 on each splicing plate 115 are both arranged in a tilted manner, and the first connecting portion 117 and the second connecting portion 118 have the same tilt direction. This design allows a preset obtuse included angle 116 to be naturally formed between inner surfaces of adjacent splicing plates 115 after latching, without needing to extra adjust the angle, which simplifies the assembly process. Specifically, tilt angles of the first connecting portion 117 and the second connecting portion 118 match the obtuse angle required to be formed by the inner surfaces of the splicing plate 115. When adjacent splicing plates 115 are latched through the first connecting portion 117 and the second connecting portion 118, a main part of the splicing plate 115 will tilt according to a preset angle, so that a stable obtuse angle is formed between adjacent inner surfaces. This integrated design not only ensures accuracy of the included angle 116, but also avoids the problem of structural instability caused by improper angle adjustment during assembly.

A first retaining plate 112 is provided at one end of the first connecting surface 101, and a second retaining plate 113 is provided at one end of the second connecting surface 102. The first retaining plate 112 and the second retaining plate 113 are respectively located at a top and a bottom of the splicing plate 115. The first connecting plate 103, the second connecting plate 108, the first retaining plate 112, and the second retaining plate 113 form a connecting space on the splicing plate 115. The connecting space can enclose and limit the first connecting portion 117 and the second connecting portion 118 after latching, preventing the connecting portion from accidental detachment due to external collision or vibration, and simultaneously playing a certain protective role for the connecting portion to reduce direct contact of dust and moisture with the connection structure. A third through hole 114 is provided on each of the first retaining plate 112 and the second retaining plate 113. The third through hole 114 can be used for passing through a fastener. After a plurality of splicing plates 115 are sequentially latched to form a housing main body, fasteners can be used to pass through the third through holes 114 on the first retaining plate 112 and the second retaining plate 113 for fixation. The fasteners can be pins, screws, or the like, to further fix the entire structure of the housing 100 in an axial direction. Synergizing with the lateral positioning and longitudinal positioning of the latching portion 120, an all-round stable connection system is formed to ensure that the housing 100 of the fire pit will not fall apart or deform during handling or use.

Further, the splicing plate 115 includes a first connecting surface 101 and a second connecting surface 102. The first connecting surface 101 and the second connecting surface 102 are arranged adjacent to each other, and a plane in which the first connecting surface 101 is located and a plane in which the second connecting surface 102 is located intersect to form a specified angle to form a flow-guiding surface for guiding airflow on an inner wall of the housing 100, so as to support combustion of flames through the flow-guiding surface to form secondary combustion, making a flame state more stable. The specified angle is an obtuse angle. Through the arrangement of the first connecting surface 101 and the second connecting surface 102, the connecting surfaces of adjacent splicing plates 115 form a three-dimensional synergistic structure instead of a single plane contact, effectively improving the overall stability after assembly.

Preferably, the first connecting surface 101 and the second connecting surface 102 are both triangular structures, and the triangular structure of the first connecting surface 101 and the triangular structure of the second connecting surface 102 are inverted relative to each other. This design allows the splicing plates 115 to form a complementary geometric shape during connection, further enhancing tightness and stability of the connection. The triangular structure itself has good stability and can evenly distribute external forces after assembly, improving the deformation resistance of the housing 100 as a whole.

The above descriptions are merely some preferred embodiments of the present disclosure and illustrations of technical principles applied. Those skilled in the art should understand that the scope of invention involved in the embodiments of the present disclosure is not limited to technical solutions formed by specific combinations of the above technical features, and should also cover other technical solutions formed by any combinations of the above technical features or equivalent features thereof without departing from the above inventive concept. For example, technical solutions formed by replacing the above features with technical features having similar functions disclosed in (but not limited to) the embodiments of the present disclosure.

What is claimed is:

1. A fire pit with a detachable housing, comprising:
a housing;
a liner disposed within the housing; and
a grate disposed at a bottom of the liner;
wherein the housing comprises a plurality of splicing plates, the plurality of splicing plates are annularly surrounding an outer position away from an outer wall of the liner so that a clearance space exists between an inner surface of each splicing plate and the outer wall of the liner, and side portions of every two adjacent splicing plates are latched with each other.

2. The fire pit with a detachable housing according to claim 1, wherein a middle part of the grate is recessed downward to form a recess for accommodating combustible materials; and
an included angle exists between inner surfaces of every two adjacent splicing plates, and the included angle is an obtuse angle.

3. The fire pit with a detachable housing according to claim 1, wherein a first connecting portion and a second connecting portion are respectively formed on opposite side portions of each splicing plate, and when two adjacent splicing plates are connected, the first connecting portion is latched onto the second connecting portion to form a connection.

4. The fire pit with a detachable housing according to claim 3, wherein the first connecting portion comprises a latching groove, the second connecting portion comprises a latching portion matching the latching groove, a latching protrusion and a latching hole are respectively formed on the latching groove and the latching portion, and the latching portion is latched within the latching groove so that the latching protrusion is latched in the latching hole.

5. The fire pit with a detachable housing according to claim 4, wherein the first connecting portion further comprises a first connecting plate, a first latching plate, and a second latching plate, the first connecting plate is formed on one side portion of the splicing plate, the first latching plate is connected to the first connecting plate, the second latching plate is connected to the first latching plate, the first latching plate is located between the first connecting plate and the second latching plate to form the latching groove, and the latching hole is formed on the first latching plate, the second latching plate, or a connection between the first latching plate and the second latching plate.

6. The fire pit with a detachable housing according to claim 5, wherein the second connecting portion further comprises a second connecting plate, the second connecting plate is formed on the other side portion of the splicing plate, the latching portion is a third latching plate connected to the second connecting plate, the third latching plate is arranged extending toward the first connecting portion, and the latching protrusion is arranged on the third latching plate.

7. The fire pit with a detachable housing according to claim 6, wherein a first through hole is provided on the third latching plate, a second through hole is provided on the first latching plate, and when the first connecting portion is latched onto the second connecting portion, the first through hole and the second through hole are aligned with each other.

8. The fire pit with a detachable housing according to claim 3, wherein the first connecting portion and the second connecting portion on each splicing plate are both arranged in a tilted manner, and the first connecting portion and the second connecting portion have the same tilt direction.

9. The fire pit with a detachable housing according to claim 1, wherein the splicing plate comprises a first connecting surface and a second connecting surface, the first connecting surface and the second connecting surface are arranged adjacent to each other, and a plane in which the first connecting surface is located and a plane in which the second connecting surface is located intersect to form a specified angle to form a flow-guiding surface for guiding airflow on an inner wall of the housing; wherein the specified angle is an obtuse angle.

10. The fire pit with a detachable housing according to claim 9, wherein the first connecting surface and the second connecting surface are both triangular structures, and the triangular structure of the first connecting surface and the triangular structure of the second connecting surface are inverted relative to each other.
